(19) United States
(12) Patent Application Publication
(10) Pub. No.: US 2025/0333285 A1
(43) Pub. Date: Oct. 30, 2025

(54) APPARATUS FOR FILLING VIALS WITH GAS AND RELATED METHODS THEREOF

(71) Applicant: UNIVERSITY OF VIRGINIA PATENT FOUNDATION, Charlottesville, VA (US)

(72) Inventor: Alexander L. Klibanov, Charlottesville, VA (US)

(21) Appl. No.: 19/190,278

(22) Filed: Apr. 25, 2025

Related U.S. Application Data
(60) Provisional application No. 63/638,798, filed on Apr. 25, 2024.

(51) Int. Cl. B67C 3/10; B65B 3/00

(52) U.S. Cl. CPC B67C 3/10; B65B 3/003

(57) ABSTRACT

A device including a housing defining a chamber. An input valve for an external supply of gas connected to the housing. An output valve for an external vacuum source connected to the housing. A vial retaining member disposed in the housing to hold a vial. A removable lid attachable to the housing to seal the chamber. A piston plate and an actuator to actuate the piston plate to seal the vial while the chamber is sealed.

### CROSS-REFERENCE TO RELATED APPLICATIONS

This application claims priority under 35 U.S.C. § 119 to U.S. Provisional Patent Application No. 63/638,798 filed on Apr. 25, 2024, the entire contents of which is incorporated herein by reference.

### STATEMENT REGARDING FEDERALLY SPONSORED RESEARCH OR DEVELOPMENT

This invention was made with government support under Grant EB023055 awarded by the National Institutes for Health. The government has certain rights in the invention.

### BACKGROUND

The present disclosure includes an apparatus for filling pharmaceutical vials and tubes with gas. There is the need to fill pharmaceutical vials and tubes with gases or gas mixtures, especially heavier-than air gases, to prepare sealed/stoppered vessels that can retain desirable gas for long-term stability. Monitoring and adjustment of the concentration levels and pressures of desirable gases in the enclosed space is important, to minimize presence of atmospheric air or other non-desirable gases and use the desirable gases in the most economical way.

An aspect of an embodiment of the present invention provides, among other things, an apparatus (and related method) to perform such controlled filling.

### SUMMARY

In one aspect, the present disclosure provides a device including a housing defining a chamber. An input valve for an external supply of gas is connected to the housing. An output valve for an external vacuum source is connected to the housing. A vial retaining member is disposed in the housing to hold a vial. A removable lid that is attachable to the housing seals the chamber. The device further includes a piston plate. An actuator actuates the piston plate to seal the vial while the chamber is sealed.

In some non-limiting examples, the housing includes an optically transparent material, and the device further includes an external gas concentration sensor.

In some non-limiting examples, the vial retaining member includes a removable caddy.

In some non-limiting examples, the device further includes a sensor configured to measure a concentration of gas in the chamber in real time.

In some non-limiting examples, the device further includes a controller to determine a concentration of gas based on a scale measurement and gas density.

In some non-limiting examples, the actuator is configured to actuate the piston plate to press a stopper to close the vial while the vial is stationary in the chamber.

In some non-limiting examples, the device further includes a control system to control a filling process. The filling process includes repeating until a threshold concentration is reached including the steps of depressurizing the chamber, introducing a first gas to the chamber, and measuring a concentration of the first gas using a sensor.

In some non-limiting examples, the controller depressurizes the chamber at a sufficiently high pressure that liquids contained in the vials do not boil, bubble, or foam.

According to another aspect of the present disclosure, a method is provided. The method includes providing a chamber. The chamber includes a removable lid, a piston plate, a plurality of vials, a plurality of stoppers, a vacuum source, and a gas source that contains a first gas. The method further includes loading the plurality of vials into the chamber. The method includes repeating until a threshold concentration is reached including the steps of depressurizing the chamber, introducing a first gas to the chamber, and measuring a concentration of the first gas using a sensor.

In some non-limiting examples, the sensor is an oxygen sensor.

In some non-limiting examples, the sensor is a scale.

In some non-limiting examples, the method further includes closing the plurality of vials while in the chamber, using the plurality of stoppers, responding to the threshold concentration being reached.

In some non-limiting examples, the closing the plurality of vials is performed by a piston plate that adds a force to the plurality of stoppers into a closed position.

In some non-limiting examples, the method further includes depressurizing the chamber at a sufficiently high pressure that liquids contained in the vials do not boil, bubble, or foam.

In some non-limiting examples, a removable tray holds the vials in the chamber.

In some non-limiting examples, the method further includes sterilizing the removable tray using an autoclave.

In some non-limiting examples, the plurality of vials contains a liquid. The liquid has a plurality of dispersed microbubbles.

In some non-limiting examples, the chamber has a vacuum pressure sufficiently high enough that the microbubbles stay dispersed.

In some non-limiting examples, the chamber has a vacuum pressure of greater than or equal to 0.5 atmospheres.

In some non-limiting examples, the method further includes measuring a starting weight of the chamber.

### BRIEF DESCRIPTION OF THE DRAWINGS

FIG. 1 is an isometric view of a chamber, with a removed lid according to one example of the present disclosure.

FIG. 2 is a side section view of the chamber of FIG. 1 with the lid attached, and a set of vials connected to a stopper.

FIG. 3 is side section view of the chamber of FIG. 1 with the lid attached, and the vials are not connected to a stopper.

FIG. 4 is side section view of the chamber of FIG. 1 with the bottom of the chamber rising to seal the valves.

FIG. 5 is an isometric view of a caddy for holding twelve vials.

FIG. 6 is an isometric view of the caddy of FIG. 5 entering an autoclave.

FIG. 7 is an isometric view of the caddy of FIG. 5, shown in the chamber of FIG. 1, surrounded by ambient air.

FIG. 8 is an isometric view of the caddy of FIG. 5, shown in the chamber of FIG. 1, surrounded by a mixture of ambient air and inert gas.

FIG. 9 is an isometric view of the caddy of FIG. 5, shown in the chamber of FIG. 1, surrounded by inert gas.

FIG. 10 is an isometric view of the caddy of FIG. 5, shown in the chamber of FIG. 1, with the top piston sealing the vials.

FIG. 11 is a top view of four sets of the caddy of FIG. 5, being fed by a manifold supplying inert gas.

FIG. 12 is an elevational view showing a vial inside a large syringe.

FIG. 13 an isometric view of a larger chamber, with a removed lid according to another example of the present disclosure.

FIG. 14 illustrates an example system 1400 for automatic control of a vial filling apparatus.

### DETAILED DESCRIPTION

In the foregoing specification, implementations of the disclosure have been described with reference to specific example implementations thereof. It may be evident that various modifications may be made thereto without departing from the broader spirit and scope of implementations of the disclosure as set forth in the following claims. The specification and drawings are, accordingly, to be regarded in an illustrative sense rather than a restrictive sense.

In some implementations, devices or systems disclosed herein may be utilized or installed using methods embodying aspects of the disclosure. Correspondingly, description herein of particular features, capabilities, or intended purposes of a device or system may generally be intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, may be intended to inherently include disclosure, as embodiments of the disclosure, of the utilized features and implemented capabilities of such device or system.

The present disclosure relates to an apparatus and method for filling pharmaceutical vials, flasks, and tubes with gas. In some cases, the apparatus may provide improved efficiency in gas usage compared to continuous fill processes. The system may utilize a chamber with controlled gas introduction and evacuation, allowing for precise management of gas concentrations. In some implementations, the apparatus may operate at weaker vacuum pressures compared to traditional systems. This capability may enable the filling of vials containing liquids that may not be suitable for higher vacuum pressures. For example, the system may be used to fill vials containing liquids with dispersed microbubbles, where maintaining the integrity of the microbubbles during the filling process may be desirable. The apparatus may incorporate various components such as a housing, valves, and a piston plate to facilitate the controlled gas filling process.

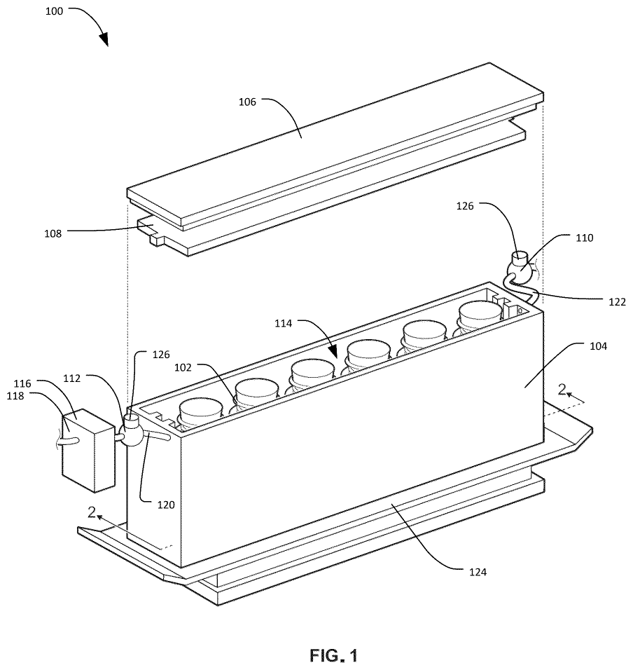

As illustrated in FIG. 1, the apparatus may comprise a chamber 100, tailored to the external size parameters of a plurality of vials 102 or tubes, so that each vial 102 may be lowered into a housing 104 of the chamber 100, thus minimizing the height and total volume of the chamber 100 inner core 114. Each vial 102 may be empty or contain a liquid, solid or gas. The liquid in the vials 102 may include a plurality of dispersed microbubbles. The chamber 100 may be constructed from various materials. For example, the chamber 100 may be constructed from stainless steel, aluminum, polycarbonate, acrylic, or glass.

The vials 102 may include pharmaceutical-type vials, flasks, tubes, ampoules, cartridges, syringes, bottles, or other containers that are commonly filled with a liquid and sealed with a stopper. The vials 102 may be manufactured from various materials. For instance, the vials 102 may be manufactured from borosilicate glass, soda-lime glass, plastic polymers such as polyethylene terephthalate (PET), or cyclic olefin copolymer (COC). The housing 104 may be fabricated using various manufacturing techniques. In some implementations, the housing 104 may be fabricated using injection molding techniques, computer numerical control (CNC) machining, or additive manufacturing technologies. The inner core 114 may be designed with specific dimensions to accommodate various standard pharmaceutical vial sizes, such as 2 mL, 5 mL, 10 mL, or 20 mL vials.

Referring to FIG. 1, the chamber 100 includes a removable lid 106, a top piston plate 108 located underneath the removable lid 106, an input valve 110, and an output valve 112. The output valve 112 and input valve 110 includes a knob 126 to control the opening and closing of the valves. An external vacuum source 116, such as a gas reclamation unit 118, may be connected to the output valve 112 using a vacuum line 120. The depressurization of the chamber may be performed at a sufficiently high pressure that liquids contained in the vial 102 do not boil, bubble, or foam, and the microbubbles stay dispersed. For example, the chamber 100 may have a vacuum pressure of greater than or equal to 0.5 atmospheres.

The removable lid 106 may be constructed from various materials. For example, the removable lid 106 may be constructed from tempered glass, polycarbonate, or aluminum with silicone gaskets to ensure proper sealing. The top piston plate 108 may be fabricated from various rigid materials. For instance, the top piston plate 108 may be fabricated from stainless steel, aluminum, or high-density polymers. The external vacuum source 116 may utilize various pump technologies. For instance, the external vacuum source 116 may be a pump, a depressurized tank or the like. The gas reclamation unit 118 may incorporate various gas capture technologies. In some implementations, the gas reclamation unit 118 may incorporate condensation coils, molecular sieves, or cryogenic separation technologies to efficiently capture and reuse gases.

A gas line 122 is connected from the chamber 100 to the input valve 110 and may further be connected to an external gas supply. The vacuum line 120 and the gas line 122 uses a flexible tubing to prevent the issue of interference from the mass of the connectors, and to allow weight measurement in real time. The chamber 100 is located on top of a scale 124 for measuring a starting mass of the chamber 100. The chamber 100 may be made of optically transparent materials, so that visual or video control of the process may be achieved. The chamber 100 may further include an external gas concentration sensor. For example, the sensor may be an oxygen sensor, a pressure gauge, a scale, etc.

The scale 124 may be implemented using various weighing technologies. In some implementations, the scale 124 may be implemented as an analytical balance, load cell-based platform scale, or strain gauge weighing with system digital readout capabilities. Implementations utilizing an external gas concentration sensor may utilize various sensing technologies depending on the specific gas being monitored. For instance, the external gas concentration sensor may utilize technologies such as paramagnetic sensing, refractometry, zirconia-based electrochemical cells, infrared absorption, or thermal conductivity detection methods.

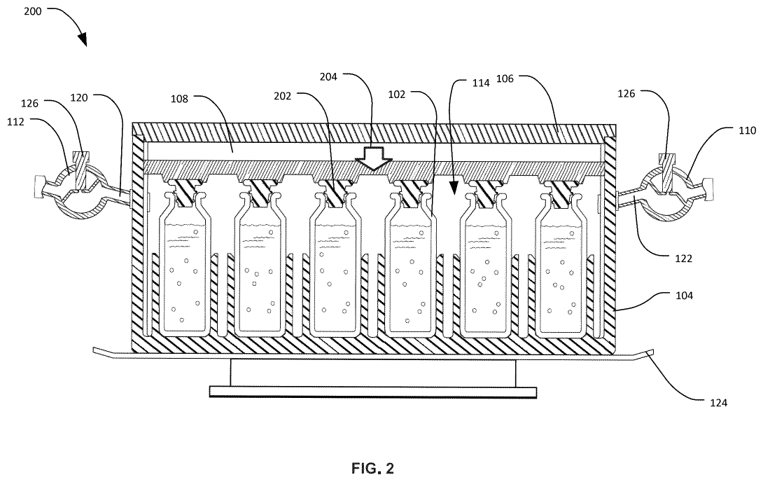

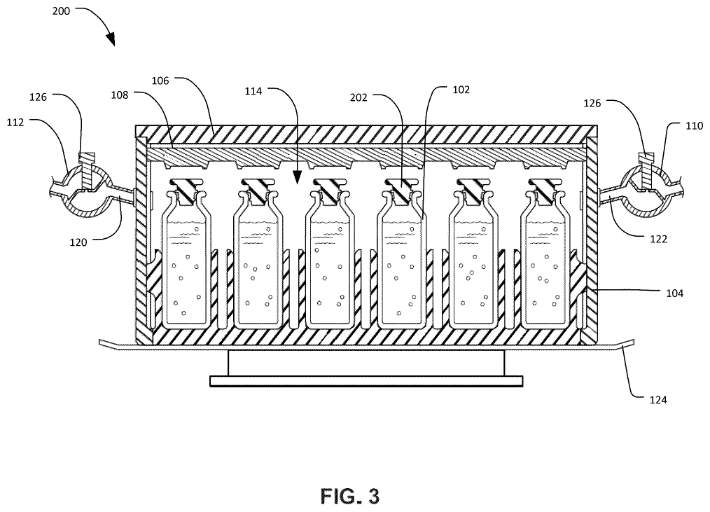

Referring now to FIGS. 2-3, in some examples, the removable lid 106 may enclose the vials 102 inside a chamber 200. The removable lid 106 may include a top piston plate 108 underneath the removable lid 106. An actuator providing an electromagnetic force may act upon the top piston plate 108 in a direction as shown in arrow 204 and closes the vials 102 using a plurality of stoppers 202 to eliminate the ability of a gas or liquid to enter or exit the vials 102. In some examples, the stoppers 202 may be a cap or a seal, to close the vials 102. Once the vials 102 are closed, the lack of electromagnetic force on the top piston plate 108 may release the vials 102.

The chamber 200 may be constructed using various materials and manufacturing techniques to maintain dimensional stability during pressure changes. For example, the chamber 200 may be constructed using machined aluminum, stainless steel, or high-strength polymers. The actuator may be implemented using various actuation technologies to provide control of the top piston plate 108 movement. For instance, the actuator may be implemented using solenoid technology, linear motors, pneumatic cylinders, or servo-driven mechanisms. The stoppers 202 may be manufactured from various elastomeric materials depending on gas permeability requirements and compatibility with the vial contents. In some implementations, the stoppers 202 may be manufactured from materials such as butyl rubber, chlorobutyl rubber, bromobutyl rubber, or silicone elastomers. The electromagnetic force may be generated using various magnetic technologies. For example, the electromagnetic force may be generated using rare earth magnets, electromagnetic coils, or a combination of permanent and electromagnets to achieve the required force profile. The arrow 204 indicates a movement path that may be guided by various linear motion components. For instance, the movement path may be guided by linear bearings, guide rods, or dovetail slides to ensure proper alignment during the sealing operation.

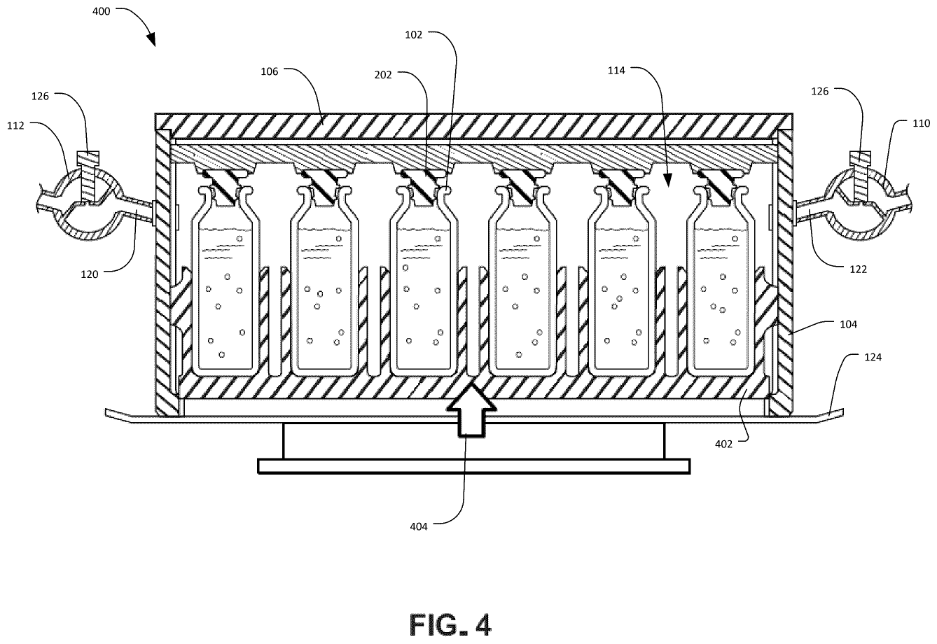

In some examples, such as FIG. 4, a chamber 400 may include a bottom piston plate 402 below the vials 102. The electromagnetic force applied to the bottom piston plate 402 in a direction as shown in an arrow 404, may push a base of the chamber 400 rises so that the stationary stoppers 202 may be inserted and close the vials 102. Once the electromagnetic force is no longer applied to the piston, the base of the chamber 400 and the vials 102 may lower back to the original level, now with stoppers 202 closing the vials 102. It is to be noted that the force applied the bottom piston plate 108 may be electromagnetic, but may also be mechanically, pneumatically, hydraulically, electrically, or magnetically.

The chamber 400 may be fabricated using various manufacturing technologies to ensure proper alignment of all components. For example, the chamber 400 may be fabricated using CNC machining, investment casting, or advanced additive manufacturing technologies. The bottom piston plate 402 may be constructed from various high-strength materials to withstand repeated actuation cycles. For instance, the bottom piston plate 402 may be constructed from materials such as hardened steel, titanium alloys, or fiber-reinforced composites. The arrow 404 indicates a movement path that may be controlled by various linear actuation mechanisms depending on the required force. In some implementations, the movement path may be controlled by hydraulic actuators, ball screws, rack and pinion mechanisms, or linear actuators. The stationary stoppers 202 may be held in position using various retention systems. For example, the stationary stoppers 202 may be held in position using custom fixtures, magnetic holders, vacuum grippers, or mechanical retention systems. The electromagnetic force may be generated by various electromagnetic components with control capabilities. For instance, the electromagnetic force may be generated by electromagnetic coils powered by programmable power supplies, allowing for control of the force profile during the sealing operation. The base of the chamber 400 may incorporate various linear guide systems to ensure smooth vertical movement during the actuation process. In some implementations, the base of the chamber 400 may incorporate linear guides, ball bearings, or air bearings.

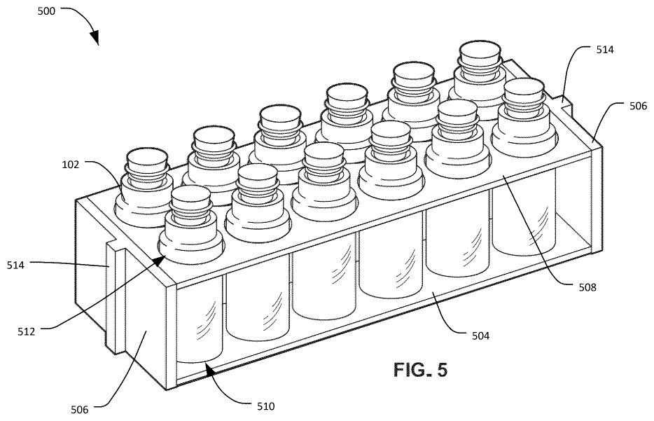

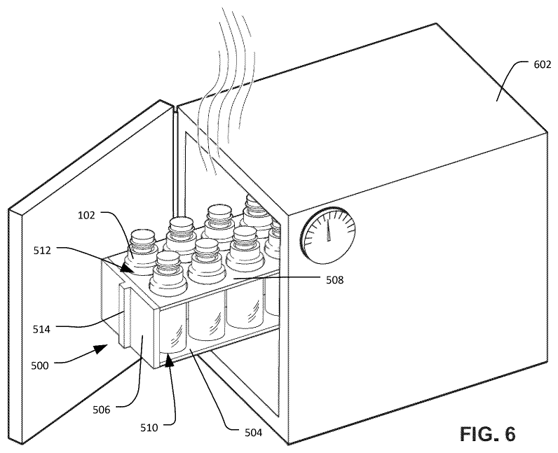

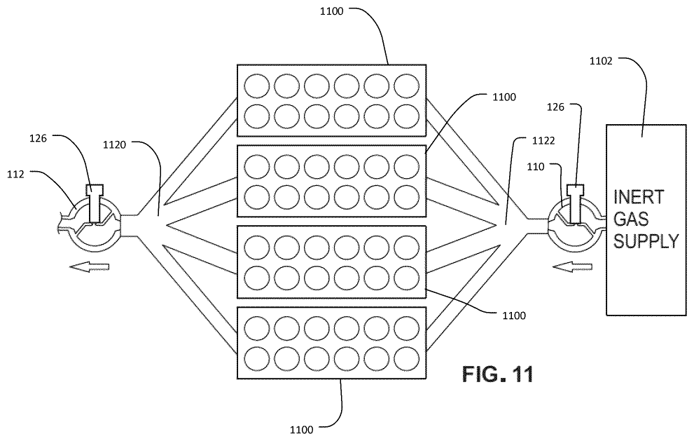

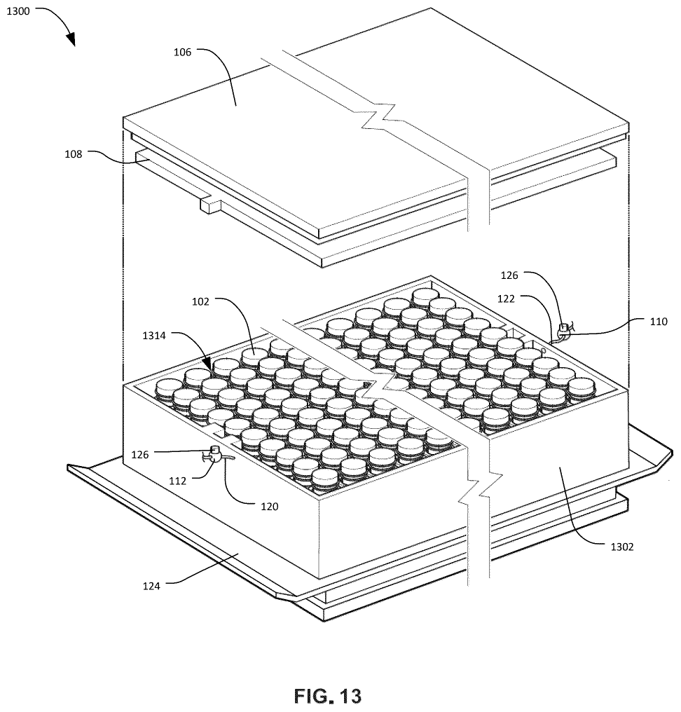

As shown in FIGS. 5-6, to begin the filling process, the vials 102 may be placed into a removable tray such as a 2×6 array caddy 500. The caddy 500 includes a base 504, two sidewalls 506, and a top portion 508. The remaining sides are open so that the sides of the vials 102 are visible. The caddy 500 contains a plurality of circumferential slots 510 on the base 504 that may be the same size as the vial 102 circumference to ensure a secure fit. The caddy 500 further includes a plurality of apertures 512 on the top portion 508 of the caddy 500 for a vial 102 to fit through so that a top portion of the vial 102 is visible. The caddy 500 may be inserted into a sterilizing device, such as an autoclave 602 shown in FIG. 6, using the handles 514 on the two sidewalls 506. It is to be noted that the caddy 500 may have any arrangement and any number of vials 102 thereon. For example, FIG. 11 and FIG. 13 show an arrangement with a over a hundred vials 102.

The caddy 500 may be manufactured from various autoclavable materials suitable for sterilization processes. For example, the caddy 500 may be manufactured from stainless steel, anodized aluminum, high-temperature resistant polymers like polyether ether ketone (PEEK), or medical-grade silicone. The base 504 may incorporate various features to facilitate proper sterilization and drying. For instance, the base 504 may incorporate drainage channels, ventilation holes, or textured surfaces. The sidewalls 506 may be designed with various structural reinforcement features to maintain structural integrity during handling and sterilization cycles. In some implementations, the sidewalls 506 may be designed with reinforcement ribs, gussets, or honeycomb structures. The top portion 508 may feature various connection mechanisms for easy assembly and disassembly. For example, the top portion 508 may feature quick-release mechanisms, snap-fit connections, or threaded fasteners. The circumferential slots 510 may be manufactured using various manufacturing techniques to ensure proper dimensional tolerances. The apertures 512 may incorporate various design features to facilitate easy insertion of vials 102. In some implementations, the apertures 512 may incorporate tapered edges, chamfers, or guide features. The handles 514 may be ergonomically designed with various features for comfortable handling. For example, the handles 514 may be designed with heat-resistant materials, textured gripping surfaces, or foldable mechanisms for compact storage.

FIG. 11 shows an arrangement similar to FIGS. 1-4 and 7-10. FIG. 11 illustrates a plurality of chambers 1100 with multiple manifolds, such as a plurality of vacuum lines 1120 extending from the output valve 112 to the chambers 1100. The output valve 112 may be connected to an external vacuum source. A plurality of gas lines 1122 extends from the input valve 110 to the chambers 1100. An external gas source 1102 is connected to the input valve 110 to introduce a gas into the chambers 1100 simultaneously.

The chambers 1100 may be constructed as modular units using various standardized components to allow for scalable system configurations based on production requirements. For example, the chambers 1100 may be constructed using standardized components, allowing for scalable system configurations. The vacuum lines 1120 may be implemented using various vacuum-rated connection technologies. For instance, the vacuum lines 1120 may be implemented using vacuum-rated flexible hoses, rigid metal tubing with appropriate fittings, or specialized vacuum manifold systems with integrated valves. The external gas source 1102 may consist of various gas supply systems with appropriate regulation and filtration components. In some implementations, the external gas source 1102 may consist of compressed gas cylinders, gas generators, or centralized gas distribution systems with appropriate pressure regulators and filtration components.

FIG. 13 shows an example of a larger version of a chamber 1300 similar to the chamber 100 in FIG. 1. A housing 1302 includes an inner core 1314 of the chamber 1300 that may be wide enough to hold a large amount of the vials 102.

The chamber 1300 may be fabricated using various industrial-grade materials to withstand pressure differentials during operation. For example, the chamber 1300 may be fabricated using industrial-grade materials such as thick-walled stainless steel, reinforced aluminum alloys, or composite materials. The housing 1302 may incorporate various structural design features to accommodate larger production volumes. For instance, the housing 1302 may incorporate structural reinforcements, pressure vessel design principles, or modular construction techniques. The inner core 1314 may feature various customizable holding systems to accommodate different vial sizes and arrangements. In some implementations, the inner core 1314 may feature customizable inserts, adjustable dividers, or reconfigurable holding fixtures. The vials 102 may be organized in the chamber 1300 using various organizational systems to maximize space utilization while maintaining proper spacing for gas circulation. For example, the vials 102 may be organized in the chamber 1300 using custom trays, matrix arrangements, or honeycomb structures. The chamber 1300 may include additional features to enhance production efficiency. For instance, the chamber 1300 may include additional features such as integrated temperature control systems, humidity monitoring, or automated loading/unloading mechanisms. The larger scale of chamber 1300 may necessitate enhanced sealing technologies to maintain proper pressure conditions during operation. In some implementations, the larger scale of chamber 1300 may necessitate enhanced sealing technologies such as double O-ring designs, compression gaskets, or inflatable seals.

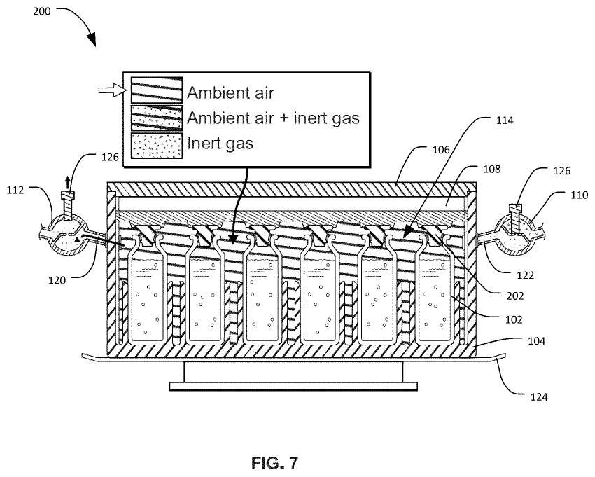

Referring now to FIG. 7, in the chamber 200 inner core 114, the vials 102 are surrounded by ambient air. The output valve 112 may be opened by rotating the knob 126 and may be connected to an external vacuum source to allow any unwanted gas, such as ambient air, to be partially released. The vacuum pressure may be low enough to prevent the liquid inside the vials 102 from boiling. The chamber 200 may be weighed on the scale to measure the weight of the chamber 200 before filling. The chamber 100 may be connected to a sensor to measure the pressure and gas levels before filling.

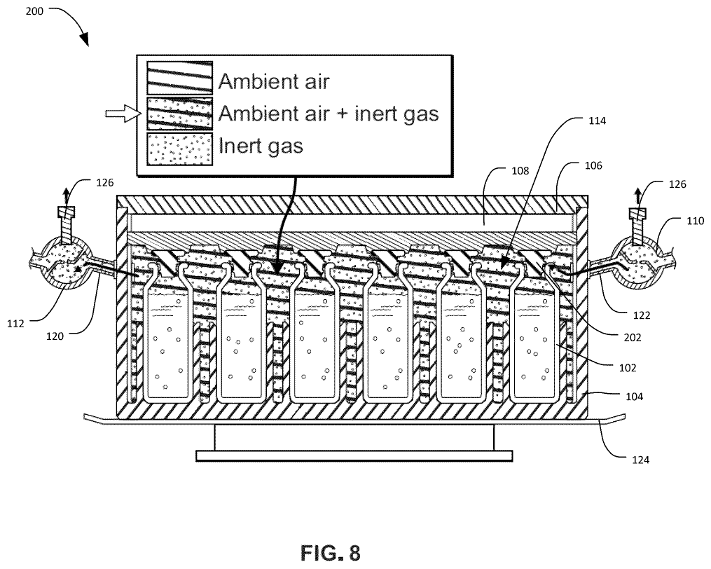

The input valve 110 of the chamber 200 may be connected to an external source that provides a desirable gas. As shown in FIG. 8, the input valve 110 may be opened, allowing the desirable gas to flow into the chamber 200, with the ambient air. The output valve 112 releasing ambient air from the chamber 200, and the input valve 110 releasing a desired gas into the chamber 200 at the same time allows the pressure within the chamber 200 to be maintained. For instance, the external source may consist of high-purity gas cylinders, gas generation systems, or centralized gas distribution networks with appropriate filtration and monitoring capabilities. The desirable gas may be introduced through various gas distribution components to promote efficient mixing and displacement of ambient air. In some implementations, the desirable gas may be introduced through specialized diffusers, perforated tubes, or directed nozzles. The pressure within the chamber 200 may be monitored using various pressure sensing technologies with appropriate data acquisition systems. For instance, the pressure within the chamber 200 may be monitored using digital pressure transducers, manometers, or differential pressure sensors. The simultaneous operation of input valve 110 and output valve 112 may be coordinated through various control systems. In some implementations, the simultaneous operation may be coordinated through electronic control systems, programmable logic controllers, or microprocessor-based automation platforms.

In some examples, a gas catcher may be attached to the output valve 112 to capture exhaust gas. The exhaust gas may be cooled to condense out and retain the desired gas.

The gas catcher may be implemented using various gas separation technologies depending on the specific gases being processed. For example, the gas catcher may be implemented using technologies such as cryogenic traps, molecular sieve adsorption systems, or membrane separation units. The cooling process may utilize various cooling technologies to achieve the required condensation temperatures. For instance, the cooling process may utilize Peltier cooling elements, liquid nitrogen heat exchangers, or mechanical refrigeration systems. The exhaust gas may be directed through various separation stages to remove particulates before the condensation process. In some implementations, the exhaust gas may be directed through a series of baffles, cyclone separators, or filtration stages. The condensed gas may be collected in specialized containers with various monitoring and safety features. For example, the condensed gas may be collected in specialized containers with appropriate pressure relief mechanisms, level indicators, or automated drainage systems. The gas catcher may incorporate various temperature monitoring technologies to ensure optimal condensation conditions. For instance, the gas catcher may incorporate temperature monitoring using thermocouples, resistance temperature detectors (RTDs), or infrared temperature sensors. The retained gas may be purified using various additional purification processes before being recycled back into the system. In some implementations, the retained gas may be purified using additional processes such as distillation, pressure swing adsorption, or catalytic conversion.

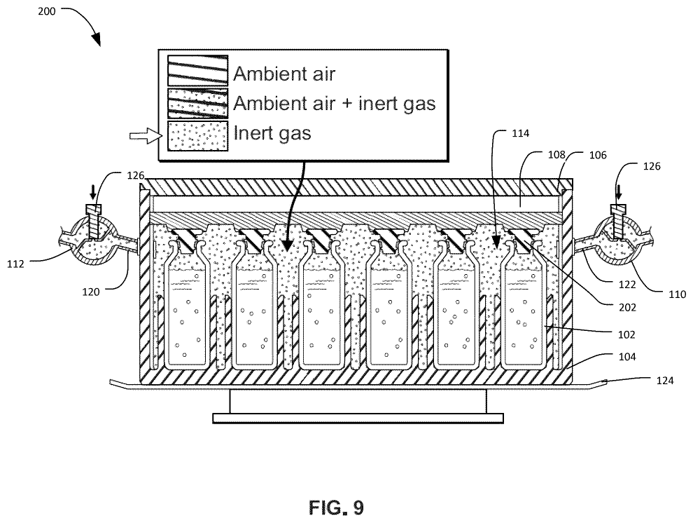

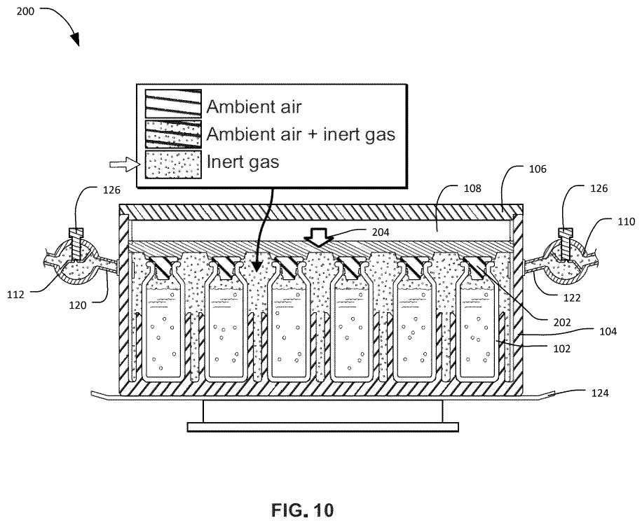

As shown in FIGS. 9-10, the chamber 200 inner core 114 may be now filled with the desired gas, and the input valve 110 and output valve 112 may be closed, trapping the desired gas inside the chamber 200. For example, the desired gas may include perfluorobutane, sulfur hexafluoride, nitrogen, argon, xenon, or carbon dioxide. In some implementations, the desired gas may be a mixture of gases such as nitrogen with small amounts of hydrogen or helium. For instance, perfluorocarbons with various chain lengths such as perfluoropropane or perfluoropentane may be used for specific pharmaceutical applications. The chamber 200 with the desired gas may be weighed by the scale 124 and a sensor may measure the pressure and gas levels in real time. If the parameters are insufficient for the desired specification, the cycle of depressurization may be repeated, to achieve sequential minimization of the presence of unwanted gas.

The input valve 110 and output valve 112 may utilize various positive sealing technologies to ensure leak-tight closure. For example, the input valve 110 and output valve 112 may utilize positive sealing technologies such as metal-to-metal seats, elastomeric diaphragms, or ball-and-seat designs. The scale 124 may be connected to data acquisition systems using various communication protocols to record weight measurements automatically. For instance, the scale 124 may be connected to data acquisition systems using RS-232, USB, Ethernet, or wireless communication protocols. The sensor systems may incorporate various gas analysis technologies for real-time gas concentration monitoring. In some implementations, the sensor systems may incorporate technologies such as paramagnetic oxygen analyzers, thermal conductivity detectors, or tunable diode laser absorption spectroscopy. The parameters may be evaluated using various programmable control systems. For example, the parameters may be evaluated using programmable logic controllers, embedded microprocessors, or industrial computers running specialized software algorithms. The cycle of depressurization may be controlled through various automated control systems. For instance, the cycle of depressurization may be controlled through automated sequencing systems, timer-based controllers, or feedback control loops based on sensor readings.

At the time when the level and pressure of the target gas or gas mixture achieve desired the stoppers 202 or septa, pistons, gaskets of other types of closures may be used to disconnect the vials 102 from the volume of the chamber 200. As described above this may be performed by the top piston plate 108. In some examples, this process may be performed using the bottom piston plate 402. For example, the stoppers 202 may be manufactured from elastomers such as bromobutyl rubber, chlorobutyl rubber, or fluoroelastomers. The septa may incorporate various laminated designs to provide both sealing capability and chemical compatibility. For instance, the septa may incorporate laminated designs with PTFE faces, silicone cores, or other composite structures. The pistons may utilize various machined components with appropriate sealing elements. In some implementations, the pistons may utilize machined components with appropriate sealing elements such as O-rings, lip seals, or custom-designed gaskets. The top piston plate 108 may be actuated using various actuation systems with appropriate force feedback mechanisms. For example, the top piston plate 108 may be actuated using servo motors, pneumatic cylinders, or hydraulic systems. The bottom piston plate 402 may incorporate various alignment features to ensure proper engagement with the vials 102. For instance, the bottom piston plate 402 may incorporate alignment features, centering mechanisms, or self-adjusting components. The disconnection process may be monitored using various sensing technologies to verify complete sealing of each vial 102. In some implementations, the disconnection process may be monitored using force sensors, position encoders, or vision systems.

It is to be noted that the method described above may be cycled at a low, maintained pressure to achieve a high purity gas without disturbing microbubbles in the liquid contained in the vials 102.

The low, maintained pressure may be regulated using various pressure control technologies with appropriate feedback systems. For example, the low, maintained pressure may be regulated using pressure controllers, proportional relief valves, or electronic pressure regulators. The cycling process may be implemented through various programmable control systems with appropriate timing parameters. For instance, the cycling process may be implemented through programmable sequencers, industrial controllers, or custom software applications. The high purity gas may be verified using various analytical techniques to confirm composition. In some implementations, the high purity gas may be verified using analytical techniques such as gas chromatography, mass spectrometry, or optical spectroscopy. The liquid contained in the vials 102 may be monitored using various non-invasive measurement techniques to detect any changes in bubble distribution. For instance, the liquid contained in the vials 102 may be monitored using optical methods, ultrasonic techniques, or electrical impedance measurements. The cycling parameters may be optimized based on various liquid properties to maintain bubble integrity throughout the process. In some implementations, the cycling parameters may be optimized based on the specific properties of the liquid, such as viscosity, surface tension, or vapor pressure.

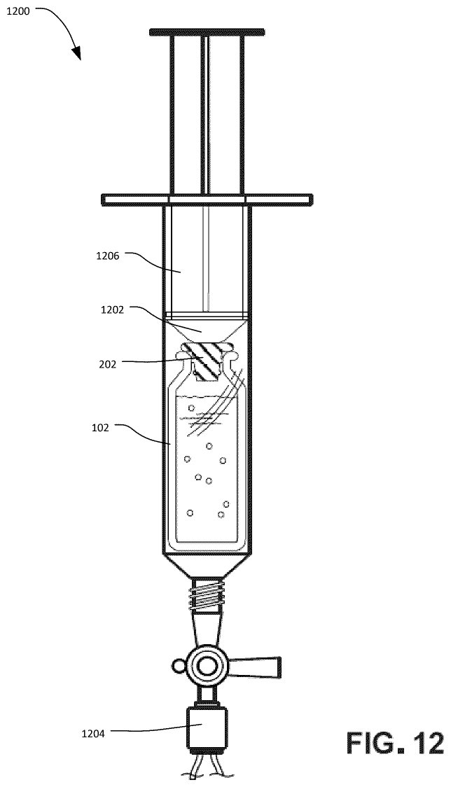

An example of the cycle described above follows. FIG. 12 illustrates a syringe barrel apparatus 1200 that contains a mechanically fixed-in-position stoppered plunger 1202 and a three-way Luer-lock stopcock valve 1204, that contains the vial 102 with half-inserted rabbit-ear stopper 202 and may be placed on analytical balance and weighed. During use, the valve 1204 may be connected to a building vacuum line (−0.8 bar) and incubated for a minute, then the valve 1204 may be closed. The syringe barrel apparatus 1200 may be disconnected and weighted, to record a reduction in weight of 13.7 mg (due to air removal from the inside of the apparatus 1200). The valve 1204 may then be connected to a Luer connector and a tube of a tank of perfluorobutane gas. After filling, the valve 1204 may be closed and apparatus 1200 may be subjected to weighing, to record the weight increase of 108.1 mg over the initial measurement, due to higher density of gas-air mixture. The valve 1204 may then be connected to the vacuum line again, to evacuate the air-gas mixture, and connected to perfluorobutane gas tank again, and weighed. The weight increase may be now recorded as 125.1 mg, due to a lower concentration of residual air in the perfluorobutane inside the apparatus at this moment in the cycle. The concentration of the gas may be determined by a controller using a scale measurement and a gas density. This sequential vacuuming-filling approach allows eventually achieving a desirably low level of residual air in perfluorobutane, at which point a plunger holder may be released 1206, and the plunger 1202 may be pushed to close the vial 102 with the stopper 202.

The syringe barrel apparatus 1200 may be constructed from various materials with appropriate chemical resistance properties. For example, the syringe barrel apparatus 1200 may be constructed from borosilicate glass, polypropylene, or polycarbonate materials. The stoppered plunger 1202 may utilize various sealing materials to provide effective sealing. For instance, the stoppered plunger 1202 may utilize PTFE-faced rubber components, silicone elastomers, or specialized composite materials. The three-way Luer-lock stopcock valve 1204 may be manufactured from various medical-grade plastics with appropriate certifications for pharmaceutical applications. In some implementations, the three-way Luer-lock stopcock valve 1204 may be manufactured from medical-grade polycarbonate, polypropylene, or polyether ether ketone (PEEK). The rabbit-ear stopper 202 may be formulated using various pharmaceutical-grade elastomers with specific durometer hardness for proper sealing characteristics. For example, the rabbit-ear stopper 202 may be formulated using pharmaceutical-grade elastomers such as bromobutyl rubber. The analytical balance may employ various high-weighing technologies. For instance, the analytical balance may employ electromagnetic force compensation technology, strain gauge sensors, or vibrating wire mechanisms to provide high-weight measurements. The building vacuum line may be equipped with various filtration components to ensure clean vacuum conditions. In some implementations, the building vacuum line may be equipped with moisture traps, particulate filters, or oil mist eliminators. The plunger holder 1206 may incorporate various quick-release mechanisms for controlled release operations. For example, the plunger holder 1206 may incorporate quick-release mechanisms, threaded retention systems, or magnetic holding fixtures.

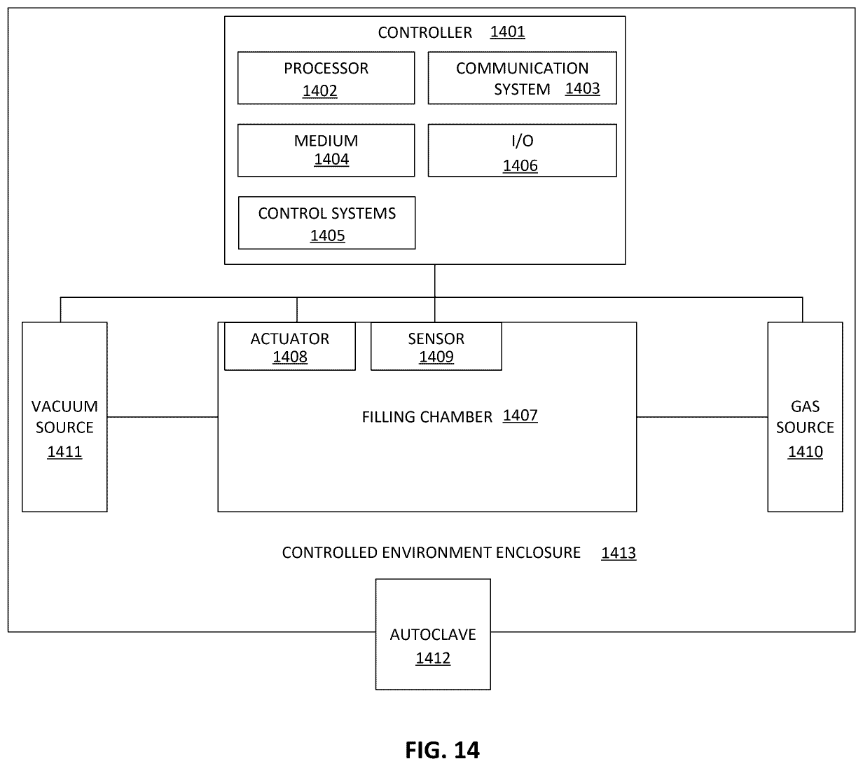

FIG. 14 illustrates an example system 1400 for automatic control of a vial filling apparatus. The system 1400 may include a controller 1401, a filling chamber 1407, a controlled environment enclosure 1413, a pass-through autoclave 1412, and associated components for filling pharmaceutical vials with gas. The controller 1401 may contain several subsystems for managing gas filling operations.

The controller 1401 may incorporate a processor 1402 and a communication system 1403 for processing and transmitting operational data. For example, the processor 1402 may be implemented using various computing technologies such as microprocessors, field-programmable gate arrays (FPGAs), or application-specific integrated circuits (ASICs). The communication system 1403 may utilize protocols such as Ethernet, Wi-Fi, or Bluetooth for data transmission under control of the processor 1402.

A medium 1404 may provide storage capabilities for the system 1400. In some implementations, the medium 1404 may include solid-state drives (SSDs), hard disk drives (HDDs), processor cache memory, random access memory (RAM), or read-only memory (ROM). The storage capacity may range from several gigabytes to multiple terabytes, depending on the data retention requirements of the system. The medium 1404 may include instructions executable by the processor 1402 to perform any method described herein, including the filling process, gas concentration monitoring, and vial sealing operations.

The processor 1402 may execute algorithms for process optimization, error detection, and data logging to ensure consistent operation of the entire system 1400. These algorithms may be implemented using programming languages such as C++, Python, or MATLAB. The processor 1402 may control the filling process in an automated fashion, including controlling the depressurization of the chamber, introduction of gas, measurement of gas concentration, and sealing of vials through the control systems 1405.

An I/O interface 1406 may enable interaction with external components and user inputs under control of the processor 1402. For example, the I/O interface 1406 may include touchscreen displays, physical buttons, or voice recognition systems for user interaction. The I/O interface 1406 may also incorporate various communication ports such as USB, RS-232, or Ethernet for connecting to external devices or networks. In some implementations, the I/O interface 1406 may connect to automated loading and unloading systems that place the removable lid 106 on the chamber and remove the lid after processing, as well as systems that automatically load and unload vials 102 and caddy 500 into and out of the filling chamber 1407.

The system 1400 may include a filling chamber 1407 positioned within a controlled environment enclosure 1413. In some examples, the filling chamber 1407 may be an implementation of chamber 100, chamber 200, chamber 400, or chamber 1300 as described above. The filling chamber 1407 may be constructed from materials such as stainless steel, borosilicate glass, or high-density polyethylene (HDPE) to ensure compatibility with various gases and maintain a controlled environment. In some cases, the filling chamber 1407 may be designed with double-walled construction for improved insulation and temperature control.

An actuator 1408 may be included within the filling chamber 1407 for controlling mechanical operations such as sealing vials. For instance, the actuator 1408 may be implemented using pneumatic cylinders, electric linear actuators, or servo motors to provide control over vial sealing operations. The actuator 1408 may be capable of applying forces ranging from a few newtons to several hundred newtons, depending on the specific sealing requirements. The processor 1402 may control the actuator 1408 through the control systems 1405, which may include motor drivers, pneumatic valve controllers, or hydraulic pressure regulators.

A sensor 1409 may be incorporated to monitor conditions within the filling chamber 1407 and provide data to the processor 1402 through the control systems 1405. For example, the sensor 1409 may include a scale 124 for measuring weight changes during the gas filling process, a chamber-internal gas concentration sensor for direct measurement of gas composition, or an optical gas sensor such as a refractometer for non-contact gas analysis. In some implementations, the sensor 1409 may incorporate technologies such as pressure transducers, oxygen sensors, or mass spectrometers to monitor gas composition and concentration. For instance, pressure sensors may have a range of 0-1000 kPa with an accuracy of ±0.1%, while oxygen sensors may detect concentrations from 0-100% with a resolution of 0.1%.

A gas source 1410 may connect to the filling chamber 1407 through the control systems 1405, which may include flow controllers, pressure regulators, or solenoid valves operated by the processor 1402. The processor 1402 may control the gas source 1410 by sending commands to the control systems 1405, which may then actuate electrical valves attached to the gas source 1410 to regulate gas flow into the filling chamber 1407. For example, the control systems 1405 may include proportional-integral-derivative (PID) controllers that adjust valve opening percentages based on feedback from the sensor 1409 to maintain gas concentrations. In some implementations, the gas source 1410 may include compressed gas cylinders, gas generators, or centralized gas distribution systems equipped with appropriate regulators and purification components. The gas source 1410 may be capable of delivering gases at pressures ranging from 100 kPa to 20 MPa, depending on the specific requirements of the filling process.

A vacuum source 1411 may connect to the filling chamber 1407 through the control systems 1405, which may include vacuum regulators, pressure sensors, or control valves operated by the processor 1402. The processor 1402 may control the vacuum source 1411 by transmitting signals to the control systems 1405, which may then operate electrical valves attached to the vacuum source 1411 to regulate the vacuum level within the filling chamber 1407. For instance, the control systems 1405 may include digital vacuum controllers that modulate butterfly valves or gate valves based on pressure readings to maintain vacuum levels during the depressurization cycle. The vacuum source 1411 may utilize various vacuum pump technologies such as rotary vane pumps, diaphragm pumps, or turbomolecular pumps to achieve the required vacuum levels for the gas filling process. These pumps may be capable of achieving vacuum levels ranging from 0.25 atmospheres to 0.8 atmospheres, or between 0.3 atmospheres and 0.7 atmospheres, or between 0.4 atmospheres and 0.6 atmospheres, depending on the specific requirements of the application.

The arrangement of components in system 1400 may allow for controlled gas introduction through the gas source 1410 and evacuation through the vacuum source 1411 under control of the processor 1402. The processor 1402 may coordinate the operation of both sources through the control systems 1405, which may include programmable logic controllers (PLCs), embedded microcontrollers, or custom electronic circuits that interface with the electrical valves on both sources. For example, the control systems 1405 may include relay boards that activate solenoid valves in a specific sequence to create alternating vacuum and gas introduction cycles. The sensor 1409 may continuously monitor conditions within the filling chamber 1407, while the actuator 1408 controls mechanical operations such as sealing vials. The processor 1402 may manage these operations through the control systems 1405, process data from the sensor 1409, and output data via I/O interface 1406 or communication system 1403.

The system 1400 may include a pass-through autoclave 1412 connected to the controlled environment enclosure 1413. The pass-through autoclave 1412 may be used to sterilize and pass trays/caddies containing filled vials or empty vials into the controlled environment enclosure 1413. The pass-through autoclave 1412 may incorporate various sterilization technologies such as steam sterilization, dry heat sterilization, or hydrogen peroxide vapor sterilization. For example, the pass-through autoclave 1412 may feature double-door designs with interlocking mechanisms to maintain environmental integrity, programmable sterilization cycles, and validation systems to ensure proper sterilization parameters are achieved. The controlled environment enclosure 1413 may include various types of controlled environments such as isolators, laminar flow chambers, biosafety cabinets, cleanrooms, gloveboxes, or RABS (Restricted Access Barrier Systems). These controlled environments may maintain specific air quality classifications (e.g., ISO 5/Class 100 or ISO 7/Class 10,000) through HEPA filtration, controlled airflow patterns, and pressure differentials to ensure aseptic processing conditions.

The system 1400 may include automated robotic handling systems connected to the control systems 1405 for transferring vials 102 between processing stations under control of the processor 1402. For instance, robotic arms with vacuum grippers, mechanical clamps, or magnetic holders may be used to manipulate vials 102 and caddy 500. The automated handling systems may be synchronized with the filling process through signals from the processor 1402 via the control systems 1405.

Practice of an aspect of an embodiment (or embodiments) of the invention will be still more fully understood from the following examples and experimental results, which are presented herein for illustration only and should not be construed as limiting the invention in any way.

As used herein in the context of computer implementation, unless otherwise specified or limited, the terms “component,” “system,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer may be a component. One or more components may reside within a process or thread of execution, may be localized on one computer, may be distributed between two or more computers or other processor devices, or may be included within another component.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

What is claimed is:

1. A device comprising:
a housing defining a chamber;
an input valve for a supply of gas connected to the housing,
an output valve for a vacuum source connected to the housing;
a vial retaining member disposed in the housing to hold a vial;
a removable lid attachable to the housing to close the chamber;
a piston plate; and
an actuator to actuate the piston plate to close the vial while the chamber is closed.

2. The device according to claim 1, further comprising a controller to control a filling process, the filling process comprising repeating, until a threshold concentration is reached, the steps of:
depressurizing the chamber;
introducing a first gas to the chamber; and
measuring a concentration of the first gas using a sensor.

3. The device according to claim 2, wherein the controller depressurizes the chamber at a sufficiently high pressure a liquid contained in the vial do not boil, bubble or foam.

4. The device according to claim 1, wherein the vial retaining member comprises a removable caddy.

5. The device according to claim 1, further comprising a sensor configured to measure a concentration of a gas in the chamber.

6. The device according to claim 5, wherein the sensor comprises a scale, and further comprising a controller to determine a concentration of a gas based on a scale measurement and a gas density.

7. The device according to claim 1, wherein the actuator is configured to actuate the piston plate to press a stopper to close the vial while the vial is stationary in the chamber.

8. The device according to claim 1, wherein the actuator is configured to actuate the piston plate to press a vial against a stationary stopper to close the vial while in the chamber.

9. A system comprising:
a gas source;
a vacuum source; and
a device comprising:
a housing defining a chamber;
an input valve for the gas source connected to the housing;
an output valve for the vacuum source connected to the housing;
a vial retaining member disposed in the housing to hold a vial;
a removable lid attachable to the housing to close the chamber;
a piston plate; and
an actuator to actuate the piston plate to close the vial while the chamber is closed.

10. The system according to claim 9, further comprising a controlled environment enclosure, wherein the device is positioned within the controlled environment enclosure.

11. The system according to claim 9, wherein the vial retaining member comprises a removable tray.

12. The system according to claim 9, further comprising a controller to control a filling process, the filling process comprising repeating, until a threshold concentration is reached, the steps of:
depressurizing the chamber;
introducing a first gas to the chamber; and
measuring a concentration of the first gas using a sensor.

13. The system according to claim 9, further comprising:
a controlled environment enclosure, wherein the device is positioned within the controlled environment enclosure;
wherein the vial retaining member comprises a removable tray;
a pass-through autoclave connected to the controlled environment enclosure to transfer the removable tray into the controlled environment enclosure; and
a controller to control a filling process, the filling process comprising repeating, until a threshold concentration is reached, the steps of:
depressurizing the chamber;
introducing a first gas to the chamber; and
measuring a concentration of the first gas using a sensor.

14. A method comprising:
providing a chamber, a plurality of vials, a plurality of stoppers, a vacuum source, and a gas source;
loading the plurality of vials into the chamber;
repeating, until a threshold concentration is reached, the steps of:
depressurizing the chamber;
introducing a first gas to the chamber; and
measuring a concentration of the first gas using a sensor;
responsive to the threshold concentration being reached, closing the plurality of vials using the plurality of stoppers while in the chamber.

15. The method according to claim 14, further comprising closing the plurality of vials using a piston plate that adds a force to the plurality of stoppers into a closed position.

16. The method according to claim 14, further comprising depressurizing the chamber at a sufficiently high pressure that liquids contained in the vials do not boil, bubble, or foam.

17. The method according to claim 14, wherein a removable tray holds the vials in the chamber.

18. The method according to claim 17, further comprising sterilizing the removable tray using an autoclave.

19. The method according to claim 14, wherein the plurality of vials contains a liquid, the liquid having a plurality of dispersed microbubbles, and wherein the chamber has a vacuum pressure sufficiently high that the microbubbles remain dispersed.

20. The method according to claim 19, wherein depressurizing the chamber comprises depressurizing the chamber under a vacuum pressure of greater than or equal to 0.5 atmospheres.
